(19) United States
(12) Patent Application Publication
(10) Pub. No.: US 2011/0243516 A1
(43) Pub. Date: Oct. 6, 2011

(54) OPTICAL WAVEGUIDE DEVICE, ELECTRONIC DEVICE, AND MANUFACTURING METHOD OF OPTICAL WAVEGUIDE DEVICE

(75) Inventor: Shigenori AOKI, Kawasaki (JP)

(73) Assignee: FUJITSU LIMITED, Kawasaki (JP)

(21) Appl. No.: 13/017,484

(22) Filed: Jan. 31, 2011

(30) Foreign Application Priority Data
Mar. 31, 2010 (JP) 2010-082145
Oct. 6, 2010 (JP) 2010-226240

(51) Int. Cl. G02B 6/02

(52) U.S. Cl. 385/123; 427/163.2

(57) ABSTRACT

An optical waveguide device includes optical waveguide wiring in which an optical waveguide crosses, and a relay part arranged at a crossing part of the optical waveguide and having a refractive index higher than that of a core of the optical waveguide.

### CROSS-REFERENCE TO RELATED APPLICATIONS

This application is based upon and claims the benefit of priority of the prior Japanese Patent Application No. 2010-226240, filed on Oct. 6, 2010, and the Japanese Patent Application No. 2010-082145, filed on Mar. 31, 2010, the entire contents of which are incorporated herein by reference.

### FIELD

The present embodiments relate to an optical waveguide device, an electronic device, and a manufacturing method of the optical waveguide device.

### BACKGROUND

In an electronic device having an optical communication function, there arises necessity to wire a plurality of optical waveguides in a high density. In optical waveguide wiring, it is possible to establish optical communication even if different optical waveguides are crossed on the same plane, however, a leakage of light (crossing loss) to another optical waveguide occurs at the crossing part.

For example, in a multimode transmission system, a loss of approximately 0.1 dB to 1 dB per crossing part occurs, where optical waveguides cross. If the number of crossings of optical waveguides increases, the effect of the loss cannot be ignored.

The leakage of light also occurs, for example, at a coupling part at which two optical waveguides are coupled to each other. For example, at a coupling part at which two optical waveguides are coupled to each other, part of light output from one of the optical waveguides does not enter the other optical waveguide but leaks out. That is, a coupling loss occurs at an output terminal from which light is output.

Note that, various structures to suppress the above-mentioned crossing loss in crossing wiring of optical waveguides are proposed. As an example, a structure in which a low refractive index region is provided around the crossing part of optical waveguides and a slit is provided therein or a structure in which optical waveguides are increased in width parabolically before and after the crossing part of optical waveguides is proposed.

Related arts are discussed in Japanese Laid-open Patent Publication No. 03-87704 and Wim Bogaerts, et al, “Low-loss, low-cross-talk crossings for silicon-on-insulator nanophotonic waveguides”, OPTICS LETTERS, Vol. 32, No. 19, pp. 2801 to 2803, 2007.

When wiring a plurality of optical waveguides in a crossing manner, if the loss of an optical signal that occurs at the crossing part of optical waveguides is large, a code error tends to occur easily during communication. From the viewpoint of facilitating high-density wiring of optical waveguides, it is demanded to reduce the size of the structure at the crossing part where the loss of an optical signal is to be suppressed.

When the loss of an optical signal that occurs at the output terminal of the optical waveguide is large, a code error also tends to occur easily during communication.

### SUMMARY

According to one aspect of embodiments, an optical waveguide device includes optical waveguide wiring in which an optical waveguide crosses, and a relay part arranged at a crossing part of the optical waveguide and having a refractive index higher than that of a core of the optical waveguide.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF THE DRAWINGS

FIG. 1 is a diagram illustrating an example of I/O circuits from CPU on a server, such as a server blade, to outside, which is an embodiment of an electronic device;

FIG. 2 is a diagram illustrating a coupling example between blades and a backboard inside a blade server;

FIG. 3 is a plan view schematically illustrating a configuration example (1) of optical waveguide wiring in an optical waveguide device;

FIG. 4 is a section view illustrating an A-A′ section in FIG. 3;

FIG. 5 is a section view illustrating a B-B′ section in FIG. 3;

FIG. 6 is a plan view schematically illustrating a configuration example (2) of optical waveguide wiring in an optical waveguide device;

FIG. 7 is a plan view illustrating an example in which a boundary between a relay part and a core is formed into an aspheric shape;

FIG. 8 is a plan view illustrating an example in which a boundary between a relay part and a core is formed into a pseudo curved surface;

FIG. 9 is a plan view schematically illustrating a configuration example (3) of optical waveguide wiring in an optical waveguide device;

FIG. 10 is a section view illustrating a C-C′ section in FIG. 9;

FIG. 11 is a diagram illustrating an example of a refractive index distribution in an optical waveguide wiring layer in the C-C′ section in FIG. 9;

FIGS. 12A-12E are a diagram schematically illustrating an example of a manufacturing method of an optical waveguide device;

FIGS. 13A-13E are a diagram schematically illustrating another example of a manufacturing method of an optical waveguide device;

FIG. 14 is a diagram illustrating a simulation result of the configuration example (2);

FIG. 15 is a diagram illustrating an outline of an embodiment;

FIG. 16 is a diagram illustrating a configuration example when three optical waveguides cross on the same plane;

FIG. 17 is a plan view schematically illustrating a configuration example of optical waveguide wiring in an optical waveguide device in another embodiment;

FIG. 18 is an exploded perspective view illustrating an outline of the optical waveguide wiring illustrated in FIG. 17;

FIG. 19 is a plan view illustrating a modified example of the optical waveguide wiring illustrated in FIG. 17; and

FIG. 20 is a plan view illustrating another modified example of the optical waveguide wiring illustrated in FIG. 17.

### DESCRIPTION OF THE EMBODIMENTS

A configuration example of a blade server as an embodiment of an optical waveguide device and an electronic device will be explained below using the drawings.

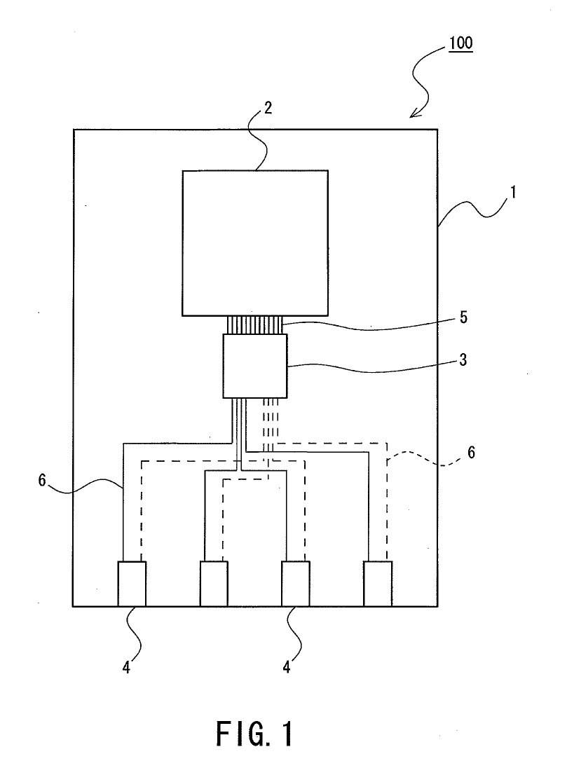

FIG. 1 illustrates an example of a blade (computer unit) 100, which is an embodiment of an electronic device. In the blade 100, on a substrate 1, which is an embodiment of an optical waveguide device, various electronic circuits are mounted. For example, the substrate 1 has an LSI 2 in charge of the key operation of a computer, an optical transceiver 3, and four optical connectors 4. The number of the optical connectors 4 is not limited to four. The LSI 2 and the optical transceiver 3 are electrically coupled by electric wiring 5. The optical transceiver 3 is a circuit that performs optical/electrical conversion of a signal input to and output from the LSI 2. The optical transceiver 3 has, for example, four sets of an optical transmission channel and an optical reception channel.

Further, on the substrate 1 as an optical waveguide device, a plurality of optical waveguides 6 that couple the optical transceiver 3 and the optical connector 4 is wired. The sets of the optical transmission channel and the optical reception channel of the optical transceiver 3 are coupled to the different optical connectors 4, respectively, by the optical waveguide 6. In FIG. 1, the optical waveguides 6 of the optical transmission channel are denoted by the respective solid lines and the optical waveguides 6 of the optical reception channel are denoted by the respective broken lines.

The wiring of the optical waveguides 6 described above is arranged on the same plane of the substrate 1, respectively. Consequently, the optical waveguides 6 on the substrate 1 cross on the same plane. A configuration of optical waveguide wiring in an embodiment will be described later.

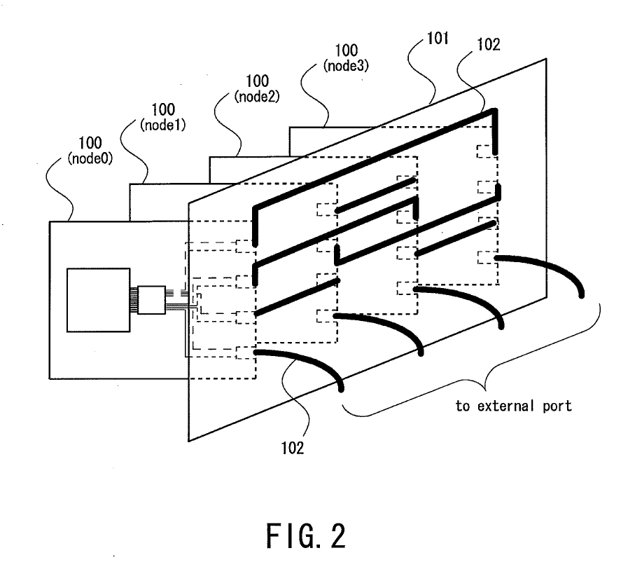

FIG. 2 illustrates a coupling example between the blades 100 and a backboard 101 inside a blade server. The blade server has the backboard 101 capable of coupling a plurality of the blades 100 in an attachable/detachable manner. The backboard 101 has an optical connector (not illustrated schematically) that engages with each of the optical connectors 4 of the blade 100. The backboard 101 couples between the different blades 100 or the blade 100 and an external device (not illustrated schematically) by, for example, optical interconnection 102 using an optical fiber cable. With the blade server in the embodiment, it is possible to execute large-scale calculations by a plurality of LSIs 2 by coupling the plurality of the blades 100 that serve as nodes. The blade server illustrated in FIG. 2 also configures the embodiment of an electronic device.

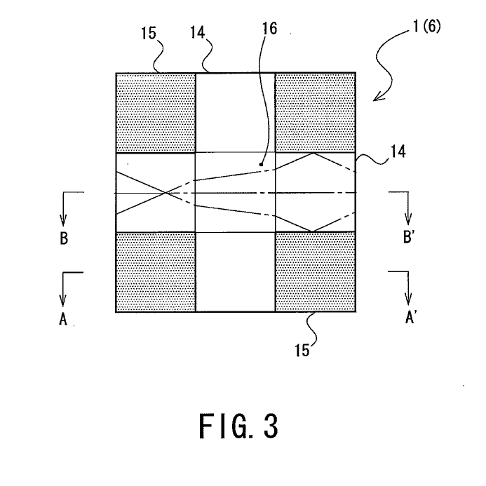

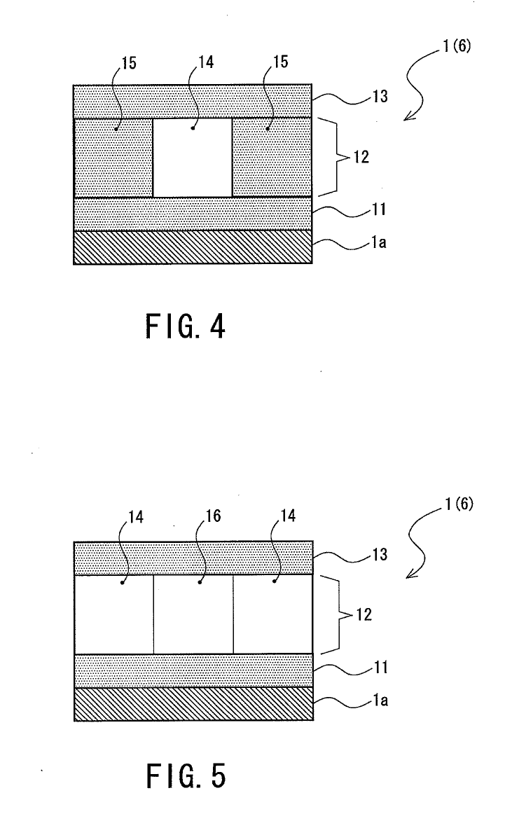

FIG. 3 is a plan view schematically illustrating a configuration example (1) of optical waveguide wiring in an optical waveguide device. In FIG. 3, the periphery of the crossing part at which two optical waveguides 6 cross is illustrated in an enlarged view. Further, in FIG. 3, the optical path of light incident to one of the optical waveguides 6 (in more detail, a core 14) is denoted schematically by the dash-dotted line. FIG. 4 illustrates an A-A′ section in FIG. 3 and FIG. 5 illustrates a B-B′ section in FIG. 3.

As illustrated in FIG. 4 and FIG. 5, in the optical waveguide device, for example, a lower clad layer 11 is formed on a substrate body 1a and an optical waveguide wiring layer 12 is formed on the lower clad layer 11. Then, on the optical waveguide wiring layer 12, an upper clad layer 13 is formed. Further, as illustrated in FIG. 3 to FIG. 5, in the optical waveguide wiring layer 12, the core 14 that guides an optical signal, a clad 15 formed outside the core 14, and a relay part 16 are formed, respectively. When viewed in the direction of the section that is substantially perpendicular to the direction in which the core 14 extends, the core 14 is formed into a substantially rectangular shape (FIG. 4).

Here, in the configuration example (1) of optical waveguide wiring, the thickness of the lower clad layer 11 and the upper clad layer 13 is, for example, about 20 μm. The thickness of the optical waveguide wiring layer 12 is, for example, approximately 35 μm. The width of the core 14 of the optical waveguide wiring layer 12 is, for example, approximately 35 μm.

As illustrated in FIG. 4, the outer circumference of the core 14 is covered with the lower clad layer 11, the upper clad layer 13, and the clad 15 of the optical waveguide wiring layer 12. Further, each of the lower clad layer 11, the upper clad layer 13, and the clad 15 of the optical waveguide wiring layer 12 has a refractive index lower than that of the core 14. Consequently, light incident to the optical waveguide 6 propagates through the optical waveguide 6 in a state of being confined in the core 14 by total reflection.

The relay part 16 in the optical waveguide wiring layer 12 is arranged at the crossing part of the core 14 of the optical waveguide 6. The refractive index of the relay part 16 is higher than that of the core 14. That is, the relay part 16 is optically denser than the core 14. Consequently, light incident to the relay part 16 from the core 14 is refracted so as to come closer to the normal of the boundary surface between the core 14 and the relay part 16. In the configuration example (1) of optical waveguide wiring, for example, when viewed in the direction of the plane (FIG. 3), the relay part 16 is formed into a shape that substantially agrees with that of the crossing part of the core 14. In the configuration example (1) of optical waveguide wiring, the refractive index of the relay part 16 is substantially uniform.

As an example, in the configuration example (1) of optical waveguide wiring, it may also be possible to set the refractive index of the clad 15 to approximately 1.65, that of the core 14 to approximately 1.67, and that of the relay part 16 to approximately 1.70. As another example, in the configuration example (1) of optical waveguide wiring, it may also be possible to set the refractive index of the clad 15 to approximately 1.60, that of the core 14 to approximately 1.62, and that of the relay part 16 to approximately 1.65.

The working in the configuration example (1) of optical waveguide wiring is described below. In the configuration example (1) of optical waveguide wiring, the relay part 16 having a refractive index higher than that of the core 14 is arranged at the crossing part of the optical waveguides 6. Light incident to the relay part 16 from the core 14 is refracted so as to come closer to the normal of the boundary surface between the core 14 and the relay part 16. Consequently, in the configuration example (1), light that propagates through one of the optical waveguides 6 is suppressed from leaking to the other optical waveguide 6 due to the refraction at the relay part 16 (refer to FIG. 3). As an example, in a multimode transmission system, higher order mode light with a large propagation angle tends not to leak to the crossing optical waveguide 6. Due to this, the crossing loss of an optical signal is reduced.

In the above configuration example (1), it is possible to set the size of the relay part 16 to substantially the same size of the crossing part of the core 14. In general, when cores having a width of 50 μm are arranged at 250 μm intervals, it is demanded to suppress the width of a structure to be provided at the crossing part of the core to five times or less than the width of the core. In the above configuration example (1), the relay part 16 having a size near to the square of the width of the core 14 can be arranged, and therefore, it is possible to easily mount the relay part 16 also when wiring the optical waveguides 6 in a crossing manner in a high density in the same plane.

In the following explanation, the same symbol is assigned to the same configuration as that of the configuration example (1) of optical waveguide wiring described above and its duplicated explanation is omitted.

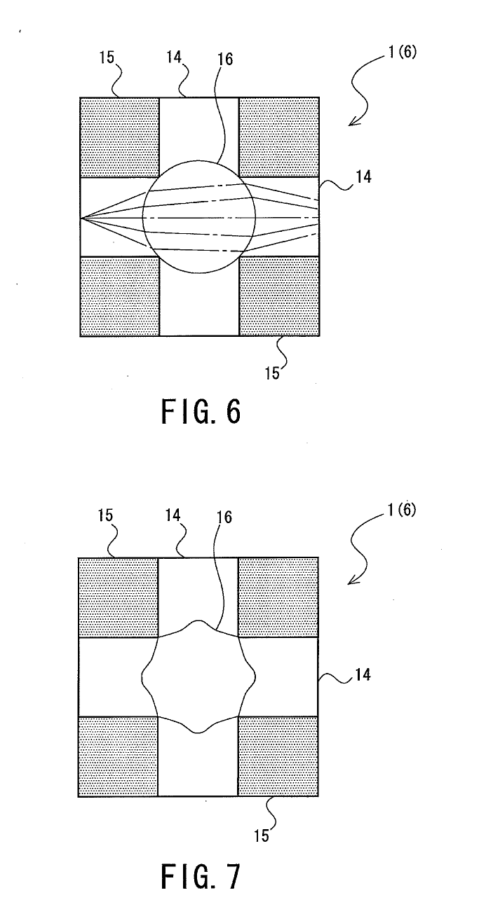

FIG. 6 is a plan view schematically illustrating a configuration example (2) of optical waveguide wiring in an optical waveguide device. In FIG. 6, the optical path of light incident to one of the optical waveguides 6 is denoted schematically by the dash-dotted line.

The configuration example (2) illustrated in FIG. 6 is a modified example of the configuration example (1) of optical waveguide wiring. In the configuration example (2), the relay part 16 is formed into a cylindrical shape having a thickness substantially the same as that of the optical waveguide wiring layer 12. For example, when viewed in the direction of the plane (FIG. 6), the edge of the relay part 16 substantially agrees with a circle circumscribing the crossing part of the core 14. That is, when viewed in the direction of the plane (FIG. 6), the boundaries between the relay part 16 and the core 14 in the optical waveguide 6 are each formed into a spherical shape convex toward the side of the core 14. Consequently, the relay part 16 works, for example, as a convex lens that converges the light flux incident to the relay part 16 from the core 14.

As described above, in the configuration example (2) of optical waveguide wiring, because of the shape of the boundary between the relay part 16 and the core 14, the relay part 16 works as a convex lens that converges light incident from the core 14. Consequently, in the above configuration example (2), light incident to the relay part 16 from one of the optical waveguides 6 is converged at the relay part 16, and therefore, it is possible to further suppress light from leaking to the crossing optical waveguide 6 compared to the configuration example (1) described above.

Further, in the above configuration example (2) also, the relay part 16 having a size near to the square of the width of the core 14 can be arranged, and therefore, it is possible to easily mount the relay part 16 when wiring the optical waveguides 6 in a crossing manner in a high density in the same plane.

Here, in the configuration example (2) of optical waveguide wiring described above, the example is explained, in which the boundary between the relay part 16 and the core 14 has a spherical shape. However, the shape of the boundary between the relay part 16 and the core 14 is not limited to the above-mentioned example.

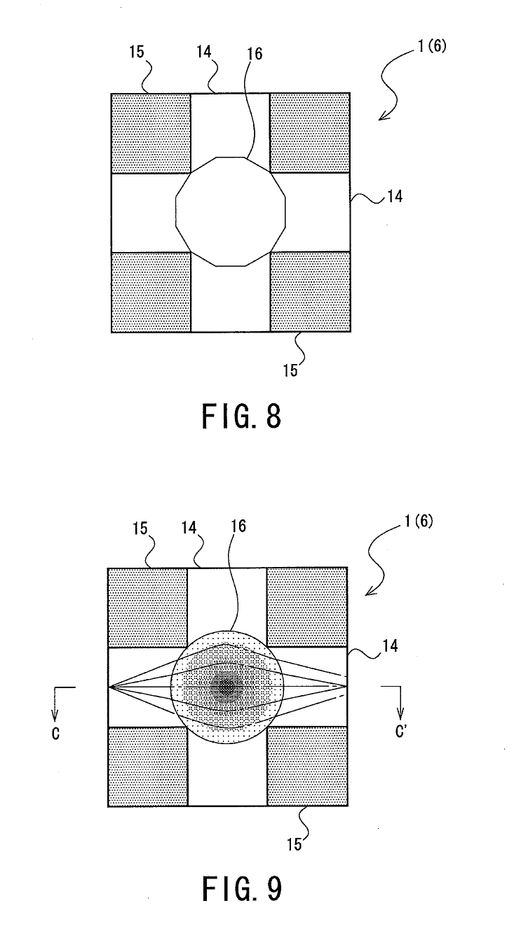

FIG. 7 illustrates an example in which the boundary between the relay part 16 and the core 14 is formed into an aspherical shape as a modified example of the configuration example (2) described above. FIG. 8 illustrates an example in which the boundary between the relay part 16 and the core 14 is formed into a pseudo curved surface formed by coupling a plurality of vertexes by straight lines as a modified example of the configuration example (2). In both the examples in FIG. 7 and FIG. 8, the refractive index of the relay part 16 is higher than that of the core 14. Further, in both the examples in FIG. 7 and FIG. 8, the boundaries between the relay part 16 and the core 14 are both a curve convex toward the side of the core 14. Consequently, the relay part 16 illustrated in FIG. 7 and FIG. 8 works as a convex lens that converges light incident from the core 14. Hence, it is possible to obtain substantially the same effect as that demonstrated in the configuration example (2) illustrated in FIG. 6 from the modified examples illustrated in FIG. 7 and FIG. 8.

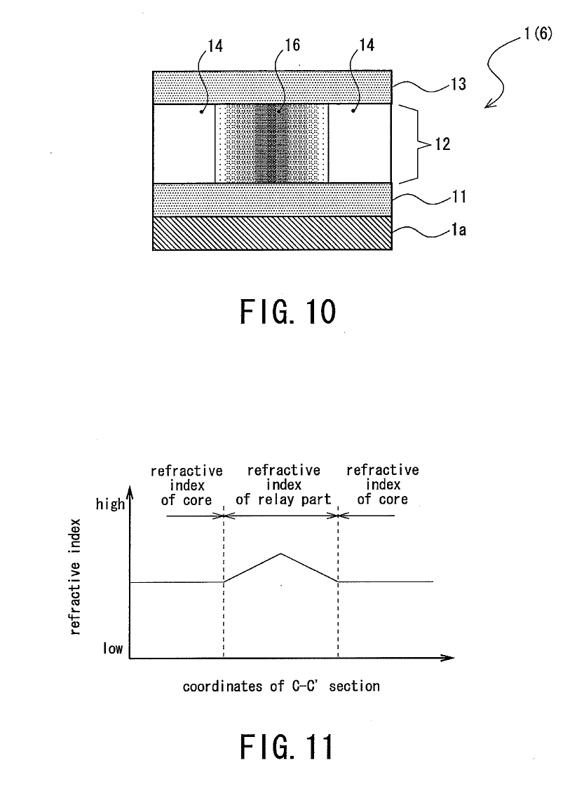

FIG. 9 is a plan view schematically illustrating a configuration example (3) of optical waveguide wiring in an optical waveguide device. FIG. 9 schematically illustrates the optical path of light incident to one of the optical waveguides 6 by the dash-dotted line. FIG. 10 illustrates a C-C′ section in FIG. 9.

In the configuration example (3) of optical waveguide wiring, as in the configuration example (2) illustrated in FIG. 6, the relay part 16 is formed into a cylindrical shape having a thickness substantially the same as that of the optical waveguide wiring layer 12.

Further, in the configuration example (3) of optical waveguide wiring, the refractive index at the center part of the relay part 16 is higher than that at the edge part of the relay part 16. For example, the relay part 16 has a gradient of refractive index in the radial direction so that the refractive index increases from the edge toward the center. In FIG. 9 and FIG. 10, the change in the refractive index of the relay part 16 is schematically represented by gradations of the hatching. The depth of the hatching in regions (for example, the clad 15) other than the relay part 16 is not related to the gradations of the hatching schematically representing the change in the refractive index of the relay part 16. When viewed in the direction of the plane (FIG. 9), the regions having the same refractive index at the relay part 16 are distributed concentrically and, the refractive index of the region increases toward the center of the relay part 16.

FIG. 11 illustrates an example of a refractive index distribution in the optical waveguide wiring layer 12 at the C-C′ section in FIG. 9. As an example, the refractive index distribution in the relay part 16 in the configuration example (3) of optical waveguide wiring is such that the refractive index at the edge of the relay part 16 is substantially the same as that of the core 14 and the refractive index increases from the edge toward the center of the relay part 16 at a linear gradient. The refractive index distribution in the relay part 16 may also be such that the gradient of refractive index changes stepwise or nonlinearly in the radial direction.

As an example, in the configuration example (3) of optical waveguide wiring, it may also be possible to set the refractive index of the clad 15 to approximately 1.65, that of the core 14 to approximately 1.67, and the gradient of refractive index of the relay part 16 in a range between approximately 1.67 and approximately 1.70. As another example, in the configuration example (3) of optical waveguide wiring, it may also be possible to set the refractive index of the clad 15 to approximately 1.60, that of the core 14 to approximately 1.62, and the gradient of refractive index of the relay part 16 in a range between approximately 1.62 and approximately 1.65.

In the configuration example (3) of optical waveguide wiring, because of the shape of the boundary between the relay part 16 and the core 14 and the gradient of refractive index in the relay part 16, the relay part 16 works as a convex lens that converges light incident from the core 14. Hence, in the configuration example (3) of optical waveguide wiring, it is possible to suppress the leakage of light to the crossing optical waveguide 6 more compared to the configuration example (1) described above.

In the configuration example (3) of optical waveguide wiring, there is a gradient of refractive index in the relay part 16 so that the refractive index increases from the edge toward the center. Consequently, there is no longer a part from the core 14 to the relay part 16 where a difference in refractive index is large, and therefore, the reflection of light from the relay part 16 becomes very slight. Hence, in the configuration example (3) described above, the loss of an optical signal due to the reflection from the relay part 16 can be suppressed.

In the configuration example (3) of optical waveguide wiring also, as in the configuration example (2) described above, it is possible to easily mount the relay part 16 when wiring the optical waveguide 6 in a crossing manner in a high density in the same plane.

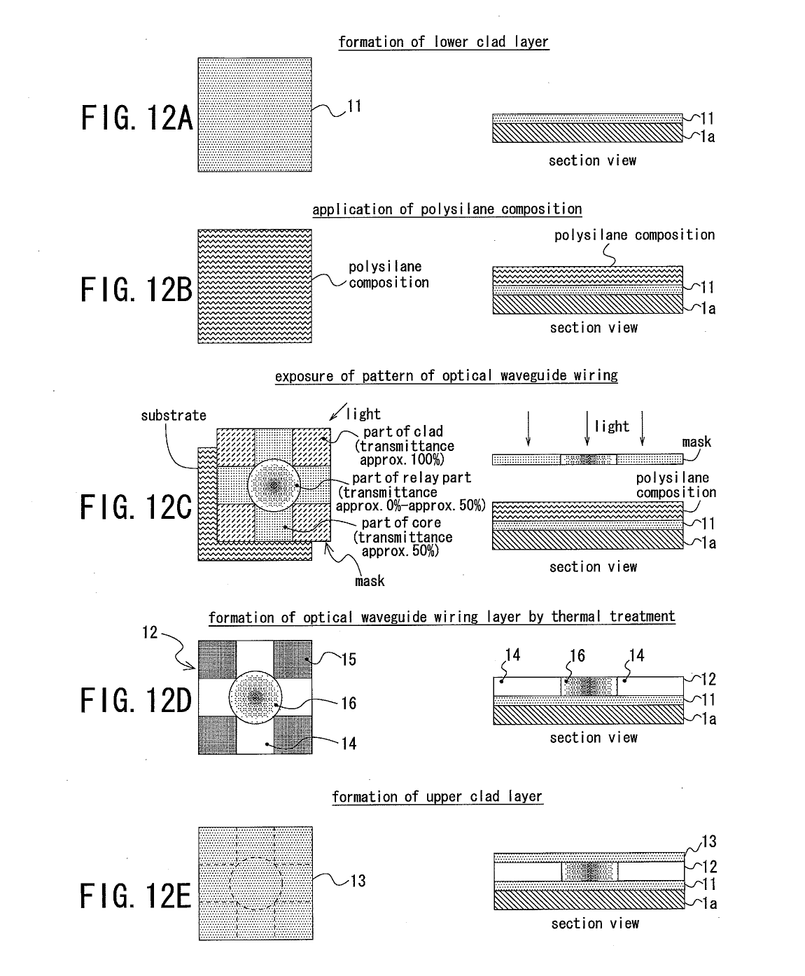

FIGS. 12A-12E schematically illustrate an example of a manufacturing method of an optical waveguide device. In an example of the manufacturing method of an optical waveguide device, the optical waveguide device is manufactured using a photopolymer material the refractive index of which is reduced by exposure. For example, the optical waveguide device is manufactured using the polysilane composition disclosed in Japanese Patent No. 4146277. The polysilane composition described above contains a branched polysilane compound and a silicone compound in a weight ratio of 30:70 to 80:20 (branched polysilane compound:silicone compound). The polysilane composition described above contains 1 to 30 pts. wt. of organic peroxide with respect to 100 pts. wt. in total of the branched polysilane compound and the silicone compound. The refractive index of the above-mentioned polysilane composition is reduced when the Si—Si bond of polysilane is cut by ultraviolet irradiation to form a Si—O—Si bond.

For example, when the above-mentioned polysilane composition is irradiated with light having a wavelength of 365 nm at a rate of approximately 10 J/cm² using a high-pressure mercury lamp (USH-500D), the refractive index (for a measuring wavelength of 850 nm) is reduced from approximately 1.70 to approximately 1.65.

First, as illustrated in FIG. 12A, the lower clad layer 11 is formed on the substrate body 1a. By, for example, spin coat, the polysilane composition is applied onto the substrate body 1a. Then, the substrate body 1a onto which the polysilane composition is applied is irradiated with light having a wavelength of 365 nm at a rate of approximately 10 J/cm² using a high-pressure mercury lamp. After that, by subjecting the substrate body 1a to thermal treatment at approximately 300° C., the lower clad layer 11 is formed on the substrate body 1a. For example, the thickness of the lower clad layer 11 is approximately 20 μm.

Next, as illustrated in FIG. 12B, the polysilane composition is applied onto the lower clad layer 11 by, for example, spin coat.

Next, as illustrated in FIG. 12C, the polysilane composition applied onto the lower clad layer 11 is exposed with a pattern of optical waveguide wiring. For example, the polysilane composition on the substrate is irradiated with light having a wavelength of 365 nm at a rate of 10 J/cm² using a high-pressure mercury lamp via a mask on which the pattern of optical waveguide wiring is formed. By such photolithography, the pattern of optical waveguide wiring is transferred onto the side of the substrate.

For example, the transmittance of the mask illustrated in FIG. 12C is approximately 100% at the part of the clad 15. The transmittance of the mask illustrated in FIG. 12C is approximately 50% at the part of the core 14. Further, the mask illustrated in FIG. 12C is provided with concentric gradations at the part where the relay part 16 is formed (crossing part of the core 14). For example, the region on the mask corresponding to the relay part 16 (hereinafter, referred to also as the part of the relay part 16 on the mask) is formed so that the transmittance increases from the center part toward the edge at a linear gradient. At the part of the relay part 16 on the mask, for example, the transmittance at the center part is approximately 0% and the transmittance at the edge is approximately 50% (the same as the transmittance at the part of the core 14).

Next, by subjecting the substrate body 1a onto which the pattern of optical waveguide wiring is transferred to thermal treatment at approximately 300° C., the optical waveguide wiring layer 12 is obtained (refer to FIG. 12D). For example, the thickness of the optical waveguide wiring layer 12 is approximately 35 μm.

Next, the upper clad layer 13 is formed on the optical waveguide wiring layer 12 (refer to FIG. 12E). The forming method of the upper clad layer 13 is substantially the same as that of the lower clad layer 11 (FIG. 12A), and therefore, its duplicated explanation is omitted. For example, the thickness of the upper clad layer 13 is approximately 20 μm.

From the above, it is possible to obtain an optical waveguide device corresponding to the configuration example (3) described above. With the manufacturing method illustrated in FIGS. 12A-12E, it is possible to manufacture an optical waveguide device in a simple process by photolithography.

For example, in the optical waveguide device obtained by the manufacturing method in FIGS. 12A-12E, the refractive index of the clad 15 is approximately 1.65, that of the core 14 is approximately 1.67, and that of the relay part 16 is approximately 1.67 to approximately 1.70. The relay part 16 has a gradient of refractive index in the radial direction and the refractive index (approximately 1.70) at the center part of the relay part 16 is higher than that (approximately 1.67) at the edge part of the relay part 16. According to the manufacturing method illustrated in FIGS. 12A-12E, the lower clad layer 11, the optical waveguide wiring layer 12, and the upper clad layer 13 are formed by the same photopolymer material. That is, the lower clad layer 11, the upper clad layer 13, the clad 15, the core 14, and the relay part 16 are formed by the same photopolymer material.

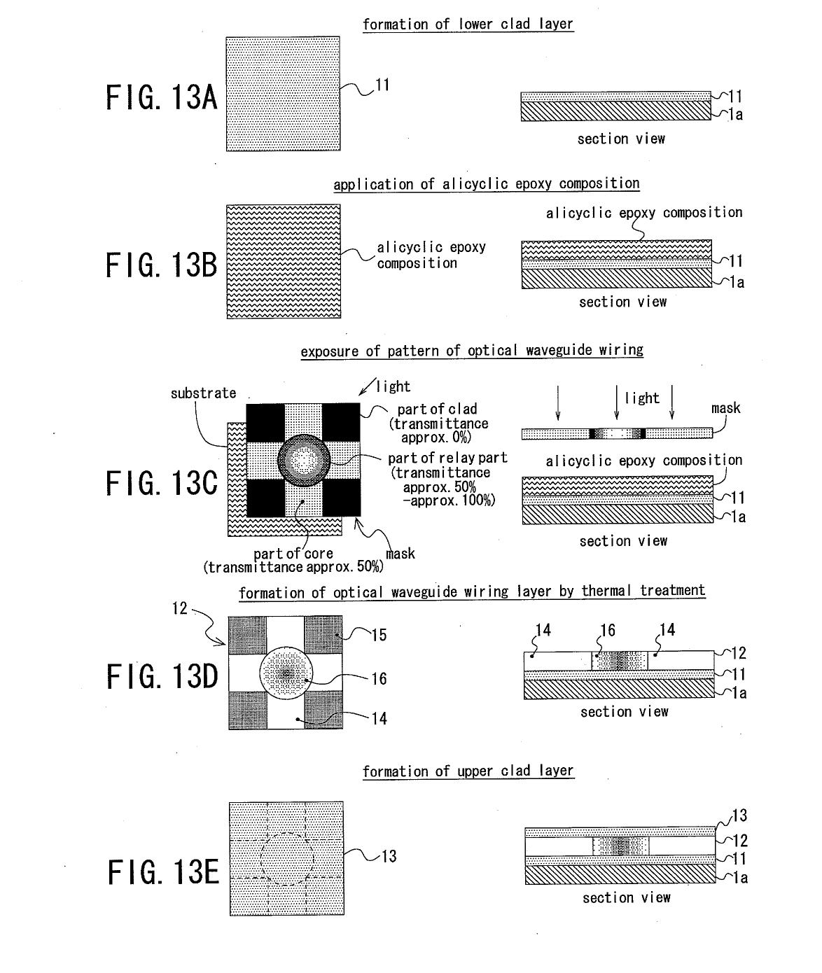

FIGS. 13A-13E schematically illustrate another example of the manufacturing method of an optical waveguide device. In another example of the manufacturing method of an optical waveguide device, the optical waveguide device is manufactured using a photopolymer material the refractive index of which increases by exposure. For example, a photopolymer material (alicyclic epoxy composition), which is a binder including an alicyclic epoxy group to which polymerizable monomer including ethylenically unsaturated group, photopolymerization initiator, and curing agent are added, is used in the manufacture of the optical waveguide device. The above-mentioned alicyclic epoxy composition can be obtained according to the disclosure of the first embodiment of the Japanese Laid-open Patent Publication No. 09-157352.

Further, the refractive index of the above-mentioned alicyclic epoxy composition is known to increase by ultraviolet irradiation. For example, when the alicyclic epoxy composition is irradiated with light having a wavelength of 185 nm at a rate of approximately 1 j/cm² using a low-pressure UV lamp (UL06DG), the refractive index (for a measuring wavelength of 850 nm) increases from approximately 1.60 to approximately 1.65.

First, as illustrated in FIG. 13A, the lower clad layer 11 is formed on the substrate body 1a. By, for example, spin coat, the above-mentioned alicyclic epoxy composition is applied onto the substrate body 1a. Then, by subjecting the substrate body 1a onto which the alicyclic epoxy composition is applied to thermal treatment at approximately 120° C. without irradiation with light, the lower clad layer 11 is formed on the substrate body 1a. For example, the thickness of the lower clad layer 11 is approximately 20 μm.

Next, as illustrated in FIG. 13B, the alicyclic epoxy composition is applied onto the lower clad layer 11 by, for example, spin coat.

Next, as illustrated in FIG. 13C, the alicyclic epoxy composition applied onto the lower clad layer 11 is exposed with a pattern of optical waveguide wiring. For example, the alicyclic epoxy composition on the substrate is irradiated with light having a wavelength of 185 nm at a rate of approximately 1 j/cm² using a low-pressure UV lamp via a mask on which the pattern of optical waveguide wiring is formed. By such photolithography, the pattern of optical waveguide wiring is transferred onto the side of the substrate.

For example, the transmittance of the mask illustrated in FIG. 13C is approximately 0% at the part of the clad 15. The transmittance of the mask illustrated in FIG. 13C is approximately 50% at the part of the core 14. Further, the mask illustrated in FIG. 13C is provided with concentric gradations at the part where the relay part 16 is formed (crossing part of the core 14). For example, the part of the relay part 16 on the mask is formed so that the transmittance decreases from the center part toward the edge at a linear gradient. At the part of the relay part 16 on the mask, for example, the transmittance at the center part is approximately 100% and the transmittance at the edge is approximately 50% (the same as the transmittance at the part of the core 14).

Next, by subjecting the substrate body 1a onto which the pattern of optical waveguide wiring is transferred to thermal treatment at approximately 120° C., the optical waveguide wiring layer 12 is obtained (refer to FIG. 13D). For example, the thickness of the optical waveguide wiring layer 12 is approximately 35 μm.

Next, the upper clad layer 13 is formed on the optical waveguide wiring layer 12 (refer to FIG. 13E). The forming method of the upper clad layer 13 is substantially the same as that of the lower clad layer 11 (FIG. 13A), and therefore, its duplicated explanation is omitted. For example, the thickness of the upper clad layer 13 is approximately 20 μm.

From the above, it is possible to obtain an optical waveguide device corresponding to the configuration example (3) described above. With the manufacturing method illustrated in FIGS. 13A-13E, it is possible to manufacture an optical waveguide device in a simple process by photolithography.

For example, in the optical waveguide device obtained by the manufacturing method in FIGS. 13A-13E, the refractive index of the clad 15 is approximately 1.60, that of the core 14 is approximately 1.62, and that of the relay part 16 is approximately 1.62 to approximately 1.65. The relay part 16 has a gradient of refractive index in the radial direction and the refractive index (approximately 1.65) at the center part of the relay part 16 is higher than that (approximately 1.62) at the edge part of the relay part 16. According to the manufacturing method illustrated in FIGS. 13A-13E, the lower clad layer 11, the optical waveguide wiring layer 12, and the upper clad layer 13 are formed by the same photopolymer material. That is, the lower clad layer 11, the upper clad layer 13, the clad 15, the core 14, and the relay part 16 are formed by the same photopolymer material.

Here, the optical waveguide device in the configuration example (2) can be manufactured by substantially the same method as that in the example in FIGS. 12A-12E or FIGS. 13A-13E. When manufacturing the optical waveguide device in the configuration example (2) according to the example in FIGS. 12A-12E, the transmittance at the position of the relay part 16 on the mask is set to substantially a low uniform value less than approximately 50%. Similarly, when manufacturing the optical waveguide device in the configuration example (2) according to the example in FIGS. 13A-13E, the transmittance at the position of the relay part 16 on the mask is set to substantially a high uniform value more than approximately 50%.

Alternatively, when manufacturing the optical waveguide device in the configuration example (2) using the alicyclic epoxy composition, it may also be possible to expose in advance only the pattern of the core 14 by photolithography in FIG. 13C. After that, it may also be possible to form the relay part 16 by irradiating the crossing part of the core 14 at which the refractive index has increased with beams converged into the shape of the relay part 16.

When manufacturing the optical waveguide device illustrated in FIG. 3, FIG. 7, and FIG. 8, it is only required to change the shape of the part of the relay part 16 on the mask in the manufacturing method in the configuration example (2) described above.

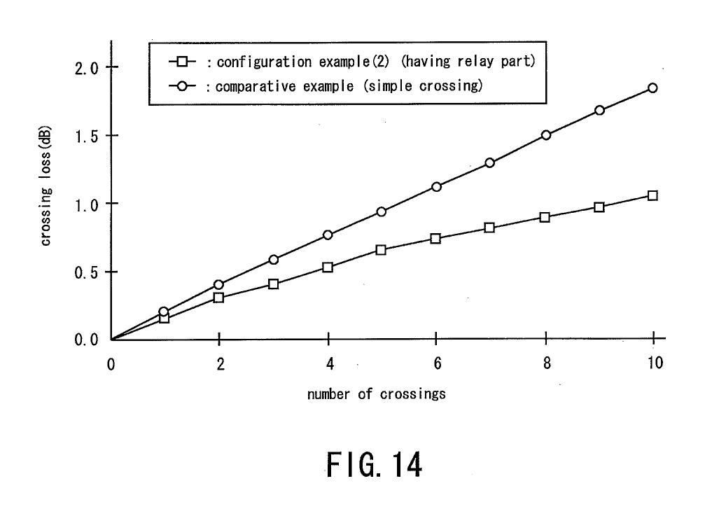

FIG. 14 illustrates a simulation result in the configuration example (2). FIG. 14 illustrates a relationship between the number of the cores 14 that cross the core 14 through which light propagates (number of crossings) and the optical loss (crossing loss). The horizontal axis in the figure represents the number of crossings and the vertical axis represents the crossing loss (in units of dB). Rectangles in the figure represent the simulation result in the configuration example (2) having the relay part 16 formed into the cylindrical shape having a thickness substantially the same as that of the optical waveguide wiring layer 12. Circles in the figure represent a comparative example in which wiring is formed with simple crossing in which the relay part 16 is not formed. Simulation conditions are illustrated below.

The simulation method is a ray tracing method. The simulation model is a channel waveguide in a three-dimensional space. The section of each of the cores 14 has the rectangular shape having a width of 35 μm and a thickness of 35 μm. The intervals of the cores 14 that cross the core 14 through which light propagates are 250 μm. The refractive index of the clad 15 is 1.63 and that of the core 14 is 1.67. The refractive index of the relay part 16 in the configuration example (2) is 1.70.

Both in the configuration example (2) and in the comparative example, the crossing loss increases as the number of crossings (number of crossing parts) increases. In the configuration example (2), the loss per crossing part is approximately 0.10 dB. On the other hand, in the comparative example, the loss per crossing part is approximately 0.18 dB. As describe above, in the configuration example (2), the loss per crossing part is reduced compared to that in the comparative example (without the relay part 16).

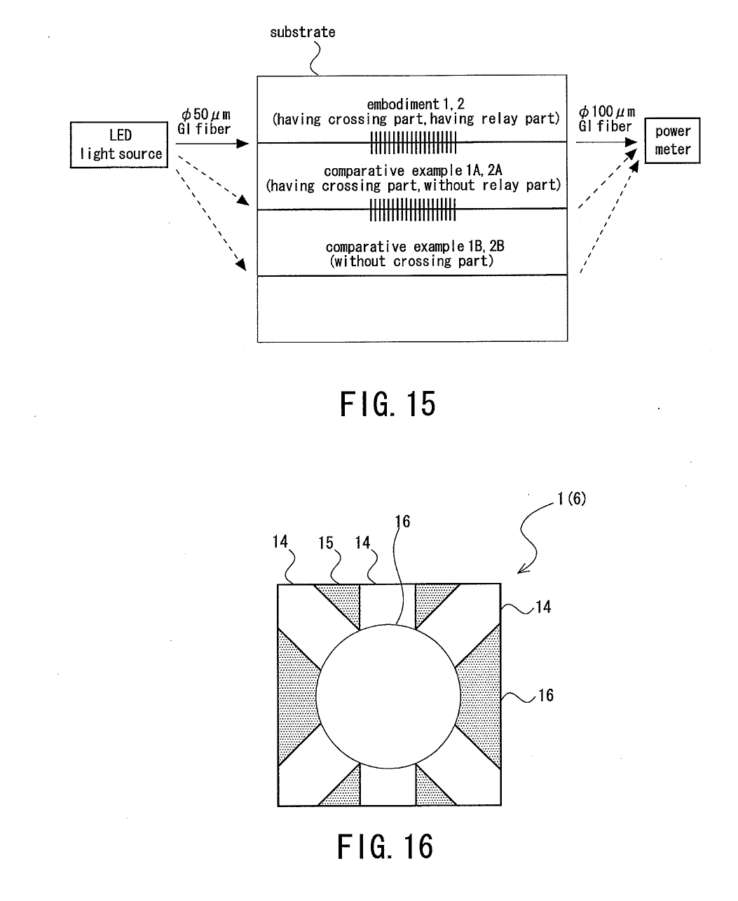

FIG. 15 illustrates an outline of the embodiment. First, a first embodiment is explained. In the first embodiment, according to the manufacturing method illustrated in FIGS. 12A-12E, optical waveguide wiring for evaluation is formed on a Si wafer having a diameter of 4 inches. The optical waveguide wiring in the first embodiment is a pattern in which each of the 20 cores 14 is perpendicular to one core 14 at the intervals of approximately 0.25 mm in a range of approximately 5 mm from the center part of one core 14 (having a wiring length of approximately 20 mm). The section of each core 14 has the rectangular shape with a width of approximately 35 μm and a thickness of approximately 35 μm. At the crossing parts of the cores 14, the respective relay parts 16 are formed. The refractive index of the clad 15 is approximately 1.65, that of the core 14 is approximately 1.67, and the gradient of the refractive index of the relay part 16 is in a range of approximately 1.67 to approximately 1.70.

A comparative example 1A and a comparative example 1B are comparative examples of the first embodiment. For example, the comparative example 1A is optical waveguide wiring with the same configuration as that in the first embodiment except in that the relay part 16 is not provided. The comparative example 1B is a rectilinear optical waveguide (approximately 35 μm wide and approximately 35 μm thick) without crossings. The comparative example 1A and the comparative example 1B are both formed in the same manufacturing process as that in the first embodiment.

Each evaluation sample of the first embodiment, the comparative example 1A, and the comparative example 1B is obtained by cutting out a substrate into a square of approximately 20 mm using a dicing saw. Then, the optical loss in each evaluation sample is measured using a power meter, for example. On the incidence side of each evaluation sample, light of a light source is introduced by coupling a GI type quartz fiber having a core diameter of 50 μm by butt joint. The light source uses LED light having a wavelength of 850 nm. On the other hand, on the output side of each evaluation sample, a power meter is coupled via a GI type quartz fiber having a core diameter of 100 μm (refer to FIG. 15).

According to the result of measurement by the power meter, the loss in the evaluation sample in the first embodiment is approximately 3.3 dB. On the other hand, the loss in the evaluation sample in the comparative example 1A is approximately 9.6 dB and the loss in the evaluation sample in the comparative example 1B is approximately 1.0 dB. Consequently, the loss per crossing part in the comparative example 1A is approximately 0.43 dB. The loss per crossing part in the first embodiment is approximately 0.12 dB. As described above, in the first embodiment, the loss per crossing part is reduced compared to the comparative example 1A.

Next, a second embodiment is explained. In the second embodiment, according to the manufacturing method illustrated in FIGS. 13A-13E, an evaluation sample is formed into the same shape as that in the first embodiment. An evaluation sample in a comparative example 2A (corresponding to the comparative example 1A) and an evaluation sample in a comparative example 2B (corresponding to the comparative example 1B) are formed in the same manufacturing process as that in the second embodiment, respectively.

Then, under the same measurement conditions as those in the first embodiment, the optical loss of each of the evaluation samples in the second embodiment, the comparative example 2A, and the comparative example 2B is measured. According to the result of measurement by the power meter, the loss in the evaluation sample in the second embodiment is approximately 4.5 dB. On the other hand, the loss in the evaluation sample in the comparative example 2A is approximately 10.6 dB and the loss in the evaluation sample in the comparative example 2B is approximately 2.4 dB. Consequently, the loss per crossing part in the comparative example 2A is approximately 0.41 dB. The loss per crossing part in the second embodiment is approximately 0.11 dB. As described above, in the second embodiment, the loss per crossing part is reduced compared to the comparative example 1A.

Here, the reason for that the losses (approximately 0.43 dB, approximately 0.41 dB) per crossing part in the comparative example 1A and the comparative example 2A are larger compared to the result (approximately 0.18 dB) in the comparative example illustrated in FIG. 14 can be thought to be the processing precision of the evaluation samples. For example, in the simulation, the core 14 on the periphery of the crossing part is an ideal shape (for example, the angle of the core 14 at the crossing part is 90 degrees). In contrast to this, in the evaluation sample, the angle of the core 14 at the crossing part is not formed into 90 degrees and the shape can be thought to be such that light is likely to leak out. In the first embodiment and the second embodiment, despite that the evaluation samples are formed in the same manufacturing process as that in the comparative example 1A and the comparative example 2A, respectively, the loss per crossing part is reduced. That is, in the present embodiment, it is possible to manufacture an optical waveguide device that has reduced the loss per crossing part in the simple process illustrated in FIGS. 12A-12E and FIGS. 13A-13E, for example.

In the above-mentioned embodiment, the configuration example is explained, in which the optical waveguides 6 (in more detail, the cores 14) are substantially perpendicular to one another. However, it is needless to say that the configuration of the relay part 16 in the above-mentioned embodiment can be applied also when the optical waveguides 6 cross at other angles.

Further, in the above-mentioned embodiment, the configuration example is explained, in which the two optical waveguides 6 cross. However, the configuration of the relay part 16 in the above-mentioned embodiment can be applied also when the three or more optical waveguides 6 cross. As an example, FIG. 16 illustrates a configuration example in which the three optical waveguides 6 cross on the same plane. In the example in FIG. 16, the configuration of the relay part 16 is the same as that in the configuration example (2). In order to cause the three or more optical waveguides 6 to cross stereoscopically at a single point, it is required to form the relay part 16 into the spherical shape.

In each example in FIG. 3, FIG. 7, and FIG. 8, it may also be possible to give a gradient of refractive index to the relay part 16 as in the configuration example (3). In the above, the refractive index at the center part of the relay part 16 may be set higher than that at the edge part of the relay part 16. In the above, parts having different refractive indexes in the relay part 16 may be arranged concentrically.

As described above, in the present embodiment, the optical waveguide device has the relay part 16 arranged at the crossing part of the optical waveguides 6. Consequently, in the present embodiment, it is possible to refract light at the relay part 16 and to suppress light from leaking to another optical waveguide 6 that is crossing. Further, in the present embodiment, for example, it is possible to reduce the size of the relay part 16 to a comparatively small one compared to the case where the width of the optical waveguide 6 is increased. As a result, in the present embodiment, it is possible to provide an optical waveguide device suitable for high-density wiring of the optical waveguide 6.

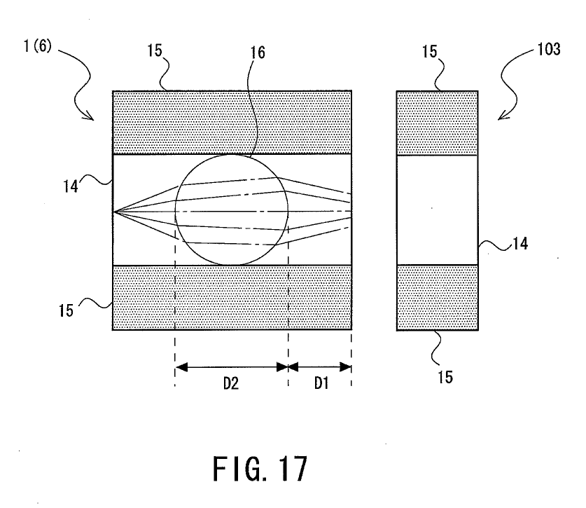

FIG. 17 is a plan view schematically illustrating a configuration example of optical waveguide wiring in an optical waveguide device in another embodiment. FIG. 17 illustrates the periphery of the output terminal of the optical waveguide 6 in an enlarged view. Further, FIG. 17 schematically illustrates the optical path of light that propagates through the optical waveguide 6 by the dash-dotted line. The same symbol is assigned to the same element as that explained in the embodiment described above and its detailed explanation is omitted. The optical waveguide device in the present embodiment has the relay part 16 arranged at the output terminal of the optical waveguide 6. Other configurations are the same as those in the embodiment described above. Further, the electronic device on which the optical waveguide device in the present embodiment is mounted is the same as that in the embodiment described above. In the present embodiment, the relay part 16 may be arranged at the crossing part of the optical waveguide 6 or may not be arranged at the crossing part of the optical waveguide 6. Further, in the present embodiment, the optical waveguide wiring may be formed including the crossing part at which the optical waveguides 6 cross or may be formed without crossing the optical waveguides 6.

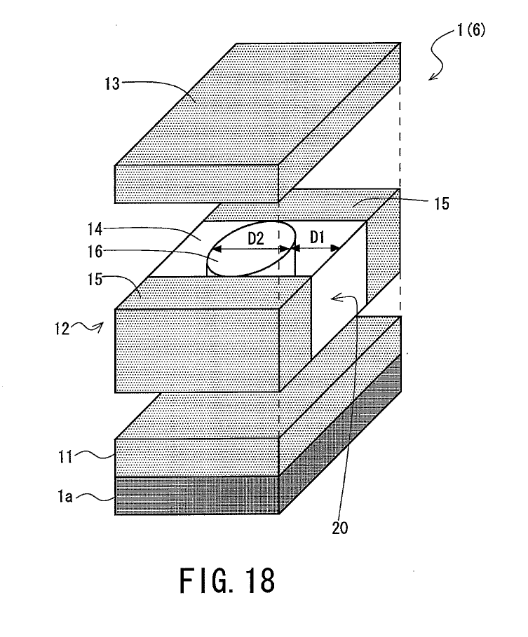

The output terminal of the optical waveguide 6 is an end part on the side from which light is output (end part on the side of the output surface 20 illustrated in FIG. 18) and formed, for example, in the optical connector illustrated 4 in FIG. 1. Then, the output terminal of the optical waveguide 6 is coupled to, for example, an optical waveguide 103 formed in the optical connector of the backboard 101 illustrated in FIG. 2 via a matching oil etc.

The relay part 16 converges, for example, the light flux incident to the relay part 16 from the side of the core 14. The relay part 16 is arranged at the output terminal so that the light flux converged at the relay part 16 does not diverge before it reaches the surface (for example, the output surface 20 illustrated in FIG. 18) of the output terminal coupled to the optical waveguide 103. For example, the relay part 16 is arranged at the output terminal so that a distance D1 between the surface of the output terminal coupled to the optical waveguide 103 and the relay part 16 is not more than a width D2 of the relay part 16.

That is, the optical waveguide 6 has the core 14 that guides an optical signal, the clad 15 formed outside the core 14, and the relay part 16 arranged at the output terminal from which the optical signal is output. The refractive index of the relay part 16 is higher than that of the core 14 and substantially uniform. As an example, in the configuration illustrated in FIG. 17, it may also be possible to set the refractive index of the clad 15 to approximately 1.65, that of the core 14 to approximately 1.67, and that of the relay part 16 to approximately 1.70. As another example, in the configuration illustrated in FIG. 17, it may also be possible to set the refractive index of the clad 15 to approximately 1.60, that of the core 14 to approximately 1.62, and that of the relay part 16 to approximately 1.65.

When viewed, for example, in the direction of the plane (FIG. 17), the edge of the relay part 16 substantially agrees with the circle inscribed in the core 14. That is, when viewed in the direction of the plane (FIG. 17), the boundaries between the relay part 16 and the core 14 in the optical waveguide 6 are each formed into the spherical shape convex toward the side of the core 14. Consequently, the relay part 16 works as, for example, a convex lens that converges the light flux incident to the relay part 16 from the side of the core 14. Hence, in the present embodiment, light is converged by the relay part 16 arranged at the output terminal, and therefore, it is possible to suppress the leakage of light output from the output terminal. That is, in the example in FIG. 17, the coupling loss that occurs at the coupling part where the optical waveguide 6 and the optical waveguide 103 are coupled is suppressed. Further, in the present embodiment, the relay part 16 having a size near to the square of the width of the core 14 can be arranged, and therefore, it is possible to easily mount the relay part 16 in the optical connector 4 illustrated in FIG. 1.

The shape of the relay part 16 (shape when viewed in the direction of the plane) is not limited to that in the example in FIG. 17 (shape of a spherical surface). For example, the shape of the relay part 16 (shape when viewed in the direction of the plane) may be the shape illustrated in FIG. 7 and FIG. 8 (shape convex toward the side of the core 14).

FIG. 18 is an exploded perspective view illustrating an outline of the optical waveguide wiring illustrated in FIG. 17. The optical waveguide 6 has, for example, the lower clad layer 11 formed on the substrate body 1a, the optical waveguide wiring layer 12 formed on the lower clad layer 11, and the upper clad layer 13 formed on the optical waveguide wiring layer 12. For example, the thickness of the lower clad layer 11 and the upper clad layer 13 is approximately 20 μm. The thickness of the optical waveguide wiring layer 12 is, for example, approximately 35 μm.

In the optical waveguide wiring layer 12, the core 14 that guides an optical signal, the clad 15 formed outside the core 14, and the relay part 16 are formed, respectively. When viewed in the direction of the section substantially perpendicular to the direction in which the core 14 extends, the core 14 is formed into, for example, the substantially rectangular shape. The width of the core 14 in the optical waveguide wiring layer 12 is, for example, approximately 35 μm. The distance D1 from the output surface 20 from which light is output to the relay part 16 is, for example, not more than the width D2 of the relay part 16.

As illustrated in FIG. 18, the outer circumference of the core 14 is covered with the lower clad layer 11, the upper clad layer 13, and the clad 15 of the optical waveguide wiring layer 12. The lower clad layer 11, the upper clad layer 13, and the clad 15 of the optical waveguide wiring layer 12 each have a refractive index lower than that of the core 14. Hence, light incident to the optical waveguide 6 propagates through the optical waveguide 6 in the state of being confined in the core 14 by total reflection.

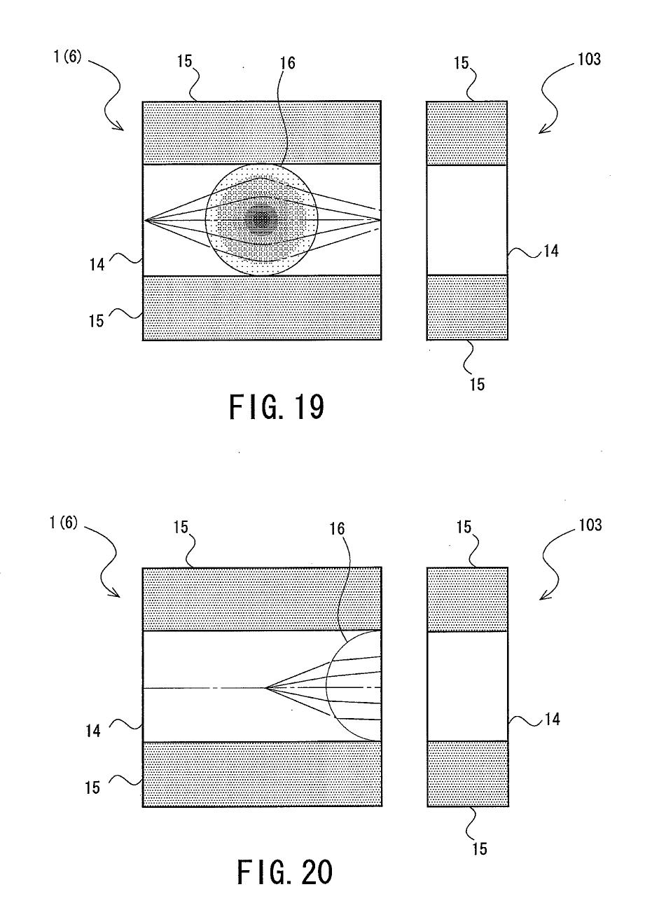

FIG. 19 is a plan view illustrating a modified example of the optical waveguide wiring illustrated in FIG. 17. In FIG. 19, the optical path of light that propagates through the optical waveguide 6 is illustrated schematically by the dash-dotted line. In the example in FIG. 19, when viewed in the direction of the plane, the refractive index at the center part of the relay part 16 is higher than that at the edge part of the relay part 16. Other configurations are the same as those of the optical waveguide 6 illustrated in FIG. 17 and FIG. 18. For example, the relay part 16 is formed into the cylindrical shape having a thickness substantially the same as that of the optical waveguide wiring layer 12. In FIG. 19, the change in the refractive index of the relay part 16 is schematically represented by the gradations of the hatching. The density of the hatching of the regions (for example, the clad 15) other than the relay part 16 is not related to the gradations of the hatching schematically illustrating the change in the refractive index of the relay part 16.

The relay part 16 has, for example, a gradient of refractive index in the radial direction so that the refractive index increases from the edge toward the center. When viewed in the direction of the plane (FIG. 19), the regions having the same refractive index in the relay part 16 are distributed concentrically, and the nearer to the center of the relay part 16, the higher is the refractive index of the region. For example, the refractive index distribution in the optical waveguide wiring layer 12 is the same as that (linear gradient) in FIG. 11. The refractive index distribution in the relay part 16 may be one in which the gradient of refractive index changes stepwise or nonlinearly in the radial direction.

As an example, in the configuration illustrated in FIG. 19, it may also be possible to set the refractive index of the clad 15 to approximately 1.65, that of the core 14 to approximately 1.67, and the gradient of refractive index of the relay part 16 to a range from approximately 1.67 to approximately 1.70. As another example, in the configuration illustrated in FIG. 19, it may also be possible to set the refractive index of the clad 15 to approximately 1.60, that of the core 14 to approximately 1.62, and the gradient of refractive index of the relay part 16 to a range from approximately 1.62 to approximately 1.65.

In the configuration illustrated in FIG. 19, because of the shape of the boundary between the relay part 16 and the core 14 and the gradient of refractive index in the relay part 16, the relay part 16 works as a convex lens that converges light incident from the core 14. Consequently, in the configuration illustrated in FIG. 19, it is possible to further suppress the leakage of light output from the output terminal compared to the configuration illustrate in FIG. 17.

In the configuration illustrated in FIG. 19, there is a gradient of refractive index in the relay part 16 so that the refractive index increases from the edge toward the center. Consequently, there is no longer a part from the core 14 and the relay part 16 where a difference in refractive index is large, and therefore, the reflection of light from the relay part 16 becomes very slight. Hence, the loss of an optical signal due to the reflection from the relay part 16 is suppressed.

FIG. 20 is a plan view illustrating another modified example of the optical waveguide wiring illustrated in FIG. 17. In FIG. 20, the optical path of light that propagates through the optical waveguide 6 is illustrated schematically by the dash-dotted line. In the example in FIG. 20, the relay part 16 is arranged so as to come into contact with the output surface 20 illustrated in FIG. 18. Further, the shape of the relay part 16 (when viewed in the direction of the plane) is substantially a semicircle convex toward the side of the core 14. Other configurations are the same as those of the optical waveguide 6 illustrated in FIG. 17 and FIG. 18. For example, the refractive index of the relay part 16 is substantially uniform.

As an example, in the configuration illustrated in FIG. 20, it may also be possible to set the refractive index of the clad 15 to approximately 1.65, that of the core 14 to approximately 1.67, and that of the relay part 16 to approximately 170. As another example, in the configuration illustrated in FIG. 20, it may also be possible to set the refractive index of the clad 15 to approximately 1.60, that of the core 14 to approximately 1.62, and that of the relay part 16 to approximately 1.65.

It is possible to manufacture the optical waveguide device illustrated in FIG. 17 to FIG. 20 by a method substantially the same as that in the example in FIGS. 12A-12E or FIGS. 13A-13E. According to the manufacturing method illustrated in FIGS. 12A-12E and FIGS. 13A-13E, the lower clad layer 11, the optical waveguide wiring layer 12, and the upper clad layer 13 are formed by the same photopolymer material. That is, the lower clad layer 11, the upper clad layer 13, the clad 15, the core 14, and the relay part 16 are formed by the same photopolymer material.

When manufacturing the optical waveguide device illustrated in FIG. 17 according to the example in FIGS. 12A-12E, the part of the relay part 16 on the mask is formed at the position corresponding to the output terminal of the optical waveguide 6 in the state where the transmittance is substantially a uniform value lower than approximately 50%. Similarly, when manufacturing the optical waveguide device illustrated in FIG. 17 according to the example in FIGS. 13A-13E, the part of the relay part 16 on the mask is formed at the position corresponding to the output terminal of the optical waveguide 6 in the state where the transmittance is substantially a uniform value higher than approximately 50%.

Further, when manufacturing the optical waveguide device illustrated in FIG. 19, the part of the relay part 16 on the mask is formed at the position corresponding to the output terminal of the optical waveguide 6 in the manufacturing method illustrated in FIGS. 12A-12E or FIGS. 13A-13E. For example, it is possible to manufacture the optical waveguide device illustrated in FIG. 20 by changing the shape and position of the part of the relay part 16 on the mask using the same manufacturing method as that of the optical waveguide device illustrated in FIG. 17.

In the embodiment illustrated in FIG. 17 to FIG. 20, the example is explained, in which the distance D1 from the output surface 20 from which light is output to the relay part 16 is not more than the width D2 of the relay part 16. However, the distance D1 from the output surface 20 from which light is output to the relay part 16 may be more than the width D2 of the relay part 16 if it is possible to reduce light that leaks out in the direction of the edge of the output surface 20.

In the embodiment illustrated in FIG. 17 to FIG. 20, the example is explained, in which the relay part 16 when viewed in the direction of the plane is inscribed in the core 14. However, the relay part 16 may be formed so as to be greater than the width of the core 14 when viewed in the direction of the plane.

In the embodiment illustrated in FIG. 17 to FIG. 19, the example is explained, in which the relay part 16 is formed into the cylindrical shape having a thickness substantially the same as that of the optical waveguide wiring layer 12. However, the relay part 16 may be formed into the shape of a sphere. Similarly, the relay part 16 illustrated in FIG. 20 may be formed into the shape of a hemisphere.

In the example in FIG. 20, it is also possible to give a gradient of refractive index to the relay part 16 as in the example in FIG. 19. For example, in the example in FIG. 20, the relay part 16 in FIG. 19, which is formed into the substantially semicircular shape, may be arranged in place of the relay part 16 in FIG. 20.

As described above, in the present embodiment, the optical waveguide device has the relay part 16 arranged at the output terminal of the optical waveguide 6. Consequently, in the present embodiment, it is possible to refract light by the relay part 16 and to suppress the leakage of light output from the output terminal. That is, in the present embodiment, it is possible to suppress the coupling loss. Further, in the present embodiment, it is possible to reduce the size of the relay part 16 to a comparatively small one compared to the case where the width of the optical waveguide 6 is increased. As a result, in the present embodiment, it is possible to provide an optical waveguide device suitable for high-density wiring of the optical waveguide 6.

According to another aspect of embodiments, an optical waveguide device is provided which includes an optical waveguide having an output surface from which light is output and a relay part arranged at the end part on the side of the output surface and having a refractive index higher than that of a core of the optical waveguide.

According to another aspect of the embodiments, an electronic device has an optical waveguide device and the optical waveguide device has optical waveguide wiring in which optical waveguides cross and a relay part arranged at the crossing part of the optical waveguides and having a refractive index higher than that of a core of the optical waveguide.

According to another aspect of the embodiments, there is provided a manufacturing method of an optical waveguide device, that forms a layer of a sensitive material the refractive index of which changes by exposure, and forms optical waveguide wiring in which optical waveguides cross, and a relay part having a refractive index higher than that of a core of the optical waveguide at the crossing part of the optical waveguides.

It is possible to provide an optical waveguide device capable of suppressing the loss of an optical signal that occurs at least one of the crossing part and the output terminal of the optical waveguide as well as suitable for high-density wiring of optical waveguides.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment of the present invention have been described in detail, it should be understood that the various changes, substitutions, and alterations could be made hereto without departing from the spirit and scope of the invention.

What is claimed is:

1. An optical waveguide device comprising:
optical waveguide wiring in which an optical waveguide crosses; and
a relay part arranged at a crossing part of the optical waveguide and having a refractive index higher than that of a core of the optical waveguide.

2. The optical waveguide device according to claim 1, wherein
a boundary between the relay part and the core in the optical waveguide is formed into a shape of a curve convex toward a side of the core.

3. The optical waveguide device according to claim 1, wherein
the refractive index at a center part of the relay part is higher than that of an edge part of the relay part.

4. The optical waveguide device according to claim 1, wherein:
the optical waveguide further includes a clad covering an outer circumference of the core and having a refractive index lower than that of the core; and
the core, the clad, and the relay part are formed by a same material.

5. An optical waveguide device comprising:
an optical waveguide having an output surface from which light is output; and
a relay part arranged at an end part on a side of the output surface and having a refractive index higher than that of a core of the optical waveguide.

6. The optical waveguide device according to claim 5, wherein
a boundary between the relay part and the core in the optical waveguide is formed into a shape of a curve convex toward a side of the core.

7. The optical waveguide device according to claim 5, wherein
the refractive index at a center part of the relay part is higher than that of an edge part of the relay part.

8. The optical waveguide device according to claim 5, wherein
a distance from the output surface to the relay part is equal to or less than a width of the relay part.

9. The optical waveguide device according to claim 5, wherein:
the optical waveguide further includes a clad covering an outer circumference of the core and having a refractive index lower than that of the core; and
the core, the clad, and the relay part are formed by a same material.

10. An electronic device having an optical waveguide device, wherein
the optical waveguide device comprises:
optical waveguide wiring in which an optical waveguide crosses; and
a relay part arranged at a crossing part of the optical waveguide and having a refractive index higher than that of a core of the optical waveguide.

11. An electron device having an optical waveguide device, wherein
the optical waveguide device comprises:
an optical waveguide having an output surface from which light is output; and
a relay part arranged at an end part on a side of the output surface and having a refractive index higher than that of a core of the optical waveguide.

12. A manufacturing method of an optical waveguide device comprising:
forming a layer of a sensitive material of which a refractive index changes by an exposure; and
forming optical waveguide wiring in which an optical waveguide crosses and a relay part having a refractive index higher than that of a core of the optical waveguide at a crossing part of the optical waveguide by exposing the layer of the sensitive material.

13. The manufacturing method of an optical waveguide device according to claim 12, wherein
the optical waveguide wiring and the relay part are formed by exposing the layer of the sensitive material using a mask having a locally different optical transmittance.

14. A manufacturing method of an optical waveguide device comprising:
forming a layer of a sensitive material of which a refractive index changes by exposure; and
forming an optical waveguide having an output surface from which light is output and a relay part having a refractive index higher than that of a core of the optical waveguide at an end part on a side of the output surface of the optical waveguide by exposing the layer of the sensitive material.

15. The manufacturing method of an optical waveguide device according to claim 14, wherein
the optical waveguide and the relay part are formed by exposing the layer of the sensitive material using a mask locally having a locally different optical transmittance.
